(19) United States
(12) Patent Application Publication
(10) Pub. No.: US 2013/0091994 A1
(43) Pub. Date: Apr. 18, 2013

(54) Drive Tool Capable of Being Coupled at Multiple Angles

(71) Applicant: Tsang-Hai Lin, Taichung City (TW)

(72) Inventor: Tsang-Hai Lin, Taichung City (TW)

(21) Appl. No.: 13/276,288

(22) Filed: Oct. 18, 2011

(51) Int. Cl. B25B 13/06; B25G 3/00

(52) U.S. Cl. 81/124.6; 81/177.85

(57) ABSTRACT

A drive tool comprises a socket body, which has a drive end for coupling to a handle and a socket end for coupling to a bolt or nut. The drive end defines a drive opening for being engaged with a drive lug of the handle. The drive opening is defined by at least two sets of engagement surfaces, all sets of engagement surfaces being evenly distributed with respect to a central line of the socket body and being spaced at intervals of an angle, each set of engagement surfaces being configured to define a sub-opening that is matched with the drive lug of the handle so that the drive lug of the handle can be engaged with each set of engagement surfaces. Thereby, the handle can be coupled to the drive tool more easily so as to facilitate an operation.

### TECHNICAL FIELD OF THE INVENTION

The present invention relates to a drive tool for use with a wrench handle, and more particularly to a drive tool capable of being coupled at multiple angles, whereby a handle can be coupled to the drive tool more easily so as to facilitate an operation.

### DESCRIPTION OF THE PRIOR ART

Fasteners, such as bolts or nuts, are used to hold parts together, which are manufactured with either imperial or metric standard and have various sizes applicable to various applications. Bolts or nuts can be turned by various types of wrenches. For reducing the space required for accommodating wrenches, socket wrenches can be employed as tools for turning bolts or nuts. Also, socket wrenches are the most widely used tools in a shop today. In use, various sizes of sockets of imperial or metric standard can be coupled to a handle for turning bolts or nuts. A conventional socket, as shown in FIG. 1, comprises a socket body 10 defining a drive end 11 and a socket end 15, in which the drive end 11 defines a drive opening 12 for coupling to a drive lug of a handle, and the socket end 15 defines a hole 16 for coupling to a bolt or nut, so that the handle may turn the socket to have the bolt or nut fastened or loosened.

Generally, the drive opening 12 of the socket body 10 has a square cross section corresponding to the drive lug of the handle, so that the socket body 10 can be effectively coupled to the handle. A user may select a suitable socket to be coupled with the handle for turning a bolt or nut. Since the drive opening 12 of the socket body 10 has a square cross section, the handle can couple with the socket body 10 at four angle positions in one circle. The angle between two adjacent angle positions is about 90 degrees, which is too large, thereby rendering a handle not easy to couple with the socket, especially when working in a tight spot. Thus, there is need for further improvement.

### SUMMARY OF THE INVENTION

The primary object of the present invention is to provide a drive tool capable of being coupled at multiple angles, whereby a handle can be coupled to the drive tool more easily so as to facilitate operation of turning bolts or nuts.

To achieve the object of the present invention, the drive tool comprises a socket body, which has a drive end for coupling to a handle and a socket end for coupling to a bolt or nut. The drive end defines a drive opening for being engaged with a drive lug of the handle. The socket end of the socket body defines a hole for fitting over one end of the bolt or nut. The drive opening is defined by at least two sets of engagement surfaces, all sets of engagement surfaces being evenly distributed with respect to a central line of the socket body and being spaced at intervals of an angle, each set of engagement surfaces being configured to define a sub-opening that is matched with the drive lug of the handle so that the drive lug of the handle can be engaged with each set of engagement surfaces.

Through the drive opening of the socket body being defined by at least two sets of engagement surfaces, the movement of a handle will require less angle, so that the handle can be coupled to the socket body more easily to facilitate operation in a tight spot.

Other objects, advantages, and novel features of the present invention will become more apparent from the following detailed description when taken in conjunction with the accompanying drawings.

### BRIEF DESCRIPTION OF THE DRAWINGS

FIG. 1 is a 3-dimensional view of a conventional socket.

FIG. 2 is a 3-dimensional view of a drive tool according to one embodiment of the present invention, in which the drive opening thereof is defined by two sets of engagement surfaces.

FIG. 3 is a 3-dimensional view of the drive tool of the embodiment, in which the drive opening thereof is defined by three sets of engagement surfaces.

FIG. 4 is a 3-dimensional view of the drive tool of the embodiment, in which the drive opening thereof is defined by four sets of engagement surfaces.

FIG. 5 schematically shows an operation of the drive tool of the embodiment.

FIG. 6 is a 3-dimensional view of a drive tool according to another embodiment of the present invention.

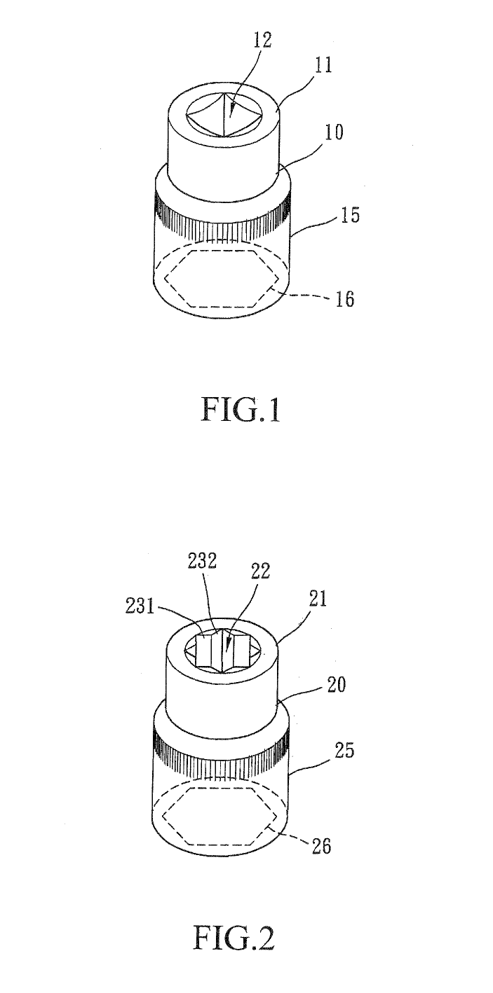

### DETAILED DESCRIPTION OF THE PREFERRED EMBODIMENTS

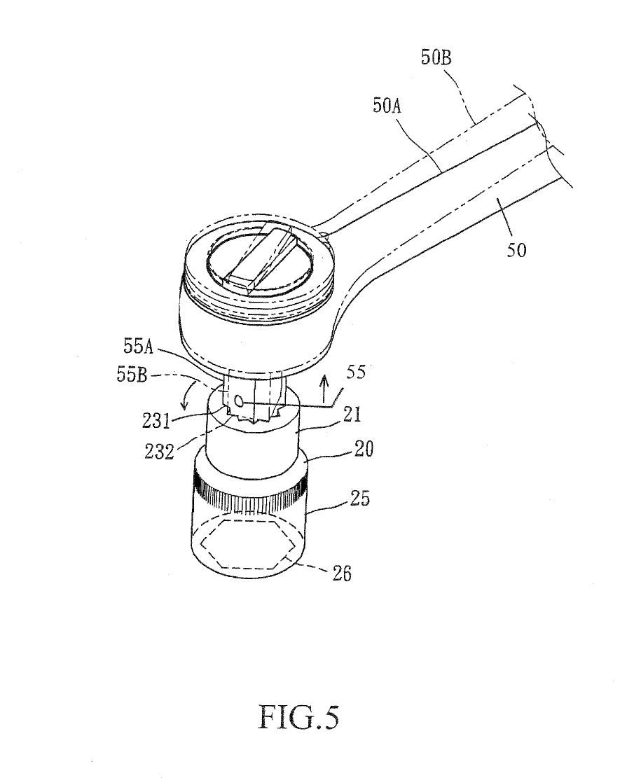

Turning now to FIG. 2, one embodiment of a drive tool for use with a handle according to the present invention is illustrated. The drive tool comprise a socket body 20, which has a drive end 21 for coupling to a handle 50 (see FIG. 5) and a socket end 25 for coupling to a bolt or nut (not shown), in which the drive end 21 defines a drive opening 22 for being engaged with a drive lug 55 of the handle 50 (see FIG. 5), and the socket end 25 defines a hole 26 for fitting over one end of the bolt or nut (not shown).

As shown in FIG. 2, the drive opening 22 may be defined by two sets of engagement surfaces 231, 232, in which reference numeral 231 represents a first set of engagement surfaces, and reference numeral 232 represents a second set of engagement surfaces. All sets of engagement surfaces 231, 232 are evenly distributed with respect to a central line of the socket body 20 and are spaced at intervals of an angle equal to 45 degrees. Each set of engagement surfaces is configured to define a square sub-opening that is matched with the drive lug 55 of the handle 50, so that the drive lug 55 of the handle 50 can be engaged with each set of engagement surfaces 231 or 232.

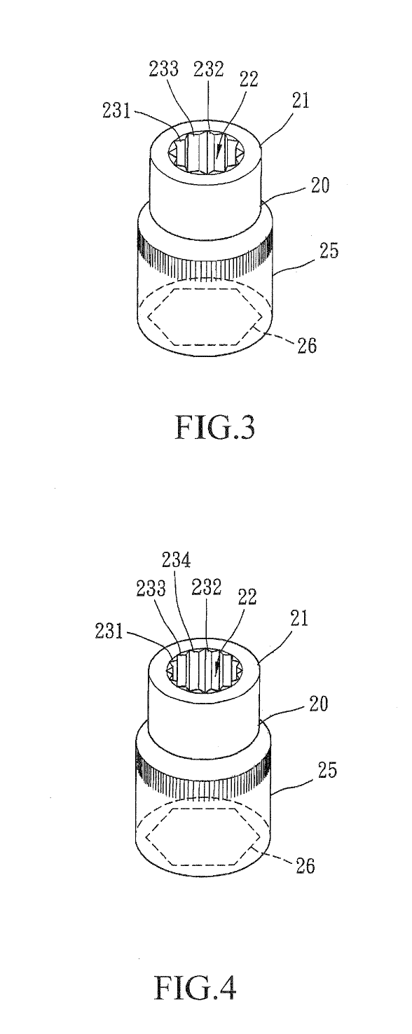

As shown in FIG. 3, the drive opening 22 may be defined by three sets of engagement surfaces 231, 232, 233, in which reference numeral 231 represents a first set of engagement surfaces, reference numeral 232 represents a second set of engagement surfaces, and reference numeral 233 represents a third set of engagement surfaces. All sets of engagement surfaces 231, 232, 233 are evenly distributed with respect to a central line of the socket body 20 and are spaced at intervals of an angle equal to 30 degrees. Each set of engagement surfaces is configured to define a square sub-opening that is matched with the drive lug 55 of the handle 50, so that the drive lug 55 of the handle 50 can be engaged with each set of engagement surfaces 231, 232 or 233.

As shown in FIG. 4, the drive opening 22 may be defined by four sets of engagement surfaces 231, 232, 233, 234, in which reference numeral 231 represents a first set of engagement surfaces, reference numeral 232 represents a second set of engagement surfaces, reference numeral 233 represents a third set of engagement surfaces, and reference numeral 234 represents a fourth set of engagement surfaces. All sets of engagement surfaces 231, 232, 233, 234 are evenly distributed with respect to a central line of the socket body 20 and are spaced at intervals of an angle equal to 15 degrees. Each set of engagement surfaces is configured to define a square sub-opening that is matched with the drive lug 55 of the handle 50, so that the drive lug 55 of the handle 50 can be engaged with each set of engagement surfaces 231, 232, 233 or 234.

Through the drive opening 22 of the socket body 20 being defined by at least two sets of engagement surfaces, a handle will be more easily coupled to the socket body 20 and can be operated together with the socket body 20 in a tight spot where a swing of the handle is limited.

In more detail, when the drive opening 22 is defined by two sets of engagement surfaces 231, 232, the handle 50 can be coupled to the socket body 20 at intervals of 45 degrees, and thus the handle 50 can be coupled to the socket body 20 at eight angle positions in one circle; when the drive opening 22 is defined by three sets of engagement surfaces 231, 232, 233, the handle 50 can be coupled to the socket body 20 at intervals of 30 degrees, and thus the handle 50 can be coupled to the socket body 20 at twelve angle positions in one circle; when the drive opening 22 is defined by four sets of engagement surfaces 231, 232, 233, 234, the handle 50 can be coupled to the socket body 20 at intervals of 15 degrees, and thus the handle 50 can be coupled to the socket body 20 at sixteen angle positions in one circle.

In operation, as shown in FIG. 5, when the socket body 20 with the handle 50 is in use, the handle 50 would be required to detach from the socket body 20 to move to another position for a next coupling. In this operation, the handle 50 may move from a first position 50 A to a second position 50B, as shown in FIG. 5. Thus, the engagement surfaces that the drive lug 55 engages with will change from the first set of engagement surfaces 231 to the second set of engagement surfaces 232. Through the drive opening 22 of the socket body 20 being defined by at least two sets of engagement surfaces, the movement of the handle 50 will require less angle for a next coupling, so that the handle 50 can be coupled with the socket body 20 more easily and operation of turning bolts or nuts will become more easy, especially in a tight spot. In a practical application, the user may employ the handle 50 to swing the socket body 20 for an angle equal to the interval between two adjacent sets of engagement surfaces, and then detach the handle 50 from the socket body 20 and move the handle 50 to the previous angle position to couple with the socket body 20 there again. Thereafter, a further swing may continue.

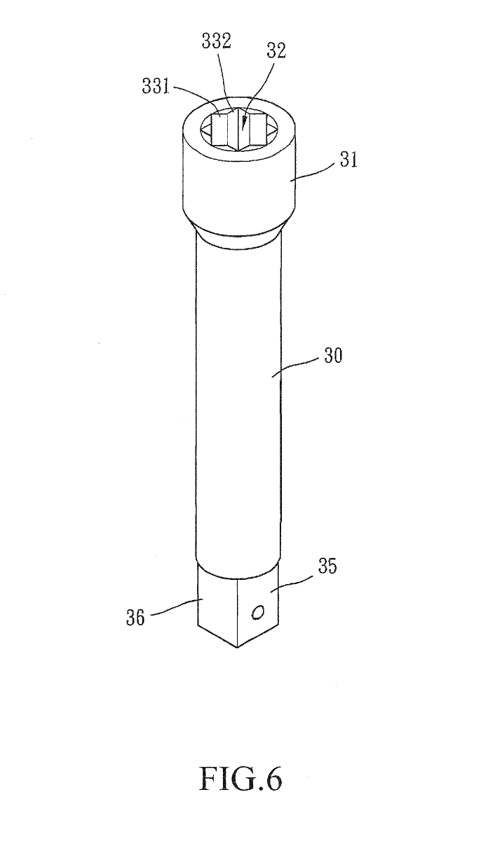

Turning now to FIG. 6, another embodiment of a drive tool for use with a handle is illustrated. The drive tool comprises an extension bar 30, which has a drive end 31 for coupling to a handle and an insertion end 35 for coupling to a socket, in which the drive end 31 defines a drive opening 32 for being engaged with a drive lug 55 of the handle 50 (see FIG. 5), the insertion end 35 is formed with flat surfaces 36 for coupling to a socket for fitting over one end of the bolt or nut (not shown). The drive opening 32 is defined by two sets of engagement surfaces 331, 332, in which reference numeral 331 represents a first set of engagement surfaces, and reference numeral 332 represents a second set of engagement surfaces. All sets of engagement surfaces 331, 332 are evenly distributed with respect to a central line of the extension bar 30 and are spaced at intervals of an angle equal to 45 degrees. Each set of engagement surfaces is configured to define a square sub-opening that is matched with the drive lug 55 of the handle 50, so that the drive lug 55 of the handle 50 can be engaged with each set of engagement surfaces 331 or 332. Through the drive opening 32 of the extension bar 30 being defined by at least two sets of engagement surfaces, a handle can be more easily coupled to the extension bar 30 and can be operated together with the extension bar 30 in a tight spot where a swing of the handle is limited. Since the drive opening 32 of the extension bar 30 has the same function and configuration as the drive opening 22 of the socket body 20, a further description therefor is omitted here.

Although the present invention has been described with a certain degree of particularity, it is understood that the present disclosure is made by way of example only and the combination and arrangement of parts may be resorted to without departing from the spirit and scope of the invention hereinafter claimed.

I claim:

1. A drive tool comprising a socket body, which has a drive end for coupling to a handle and a socket end for coupling to a bolt or nut, wherein said drive end defines a drive opening for being engaged with a drive lug of the handle, said socket end defines a hole for fitting over one end of the bolt or nut, wherein said drive opening is defined by at least two sets of engagement surfaces, all sets of engagement surfaces being evenly distributed with respect to a central line of said socket body and being spaced at intervals of an angle, each set of engagement surfaces being configured to define a sub-opening that is matched with the drive lug of the handle so that the drive lug of the handle can be engaged with each set of engagement surfaces.

2. The drive tool of claim 1, wherein said drive opening is defined by two sets of engagement surfaces, each set of engagement surfaces being configured to define a square sub-opening, so that the handle can be coupled to said socket body at intervals of 45 degrees, and the handle can be coupled to said socket body at eight angle positions in one circle.

3. The drive tool of claim 1, wherein said drive opening is defined by three sets of engagement surfaces, each set of engagement surfaces being configured to define a square sub-opening, so that the handle can be coupled to said socket body at intervals of 30 degrees, and the handle can be coupled to said socket body at twelve angle positions in one circle.

4. The drive tool of claim 1, wherein said drive opening is defined by four sets of engagement surfaces, each set of engagement surfaces being configured to define a square sub-opening, so that the handle can be coupled to said socket body at intervals of 15 degrees, and the handle can be coupled to said socket body at sixteen angle positions in one circle.

5. A drive tool comprising an extension bar, which has a drive end for coupling to a handle and an insertion end for coupling to a socket, wherein said drive end defines a drive opening for being engaged with a drive lug of the handle, said insertion end is formed with flat surfaces for coupling to a socket for fitting over one end of the bolt or nut, wherein said drive opening is defined by at least two sets of engagement surfaces, all sets of engagement surfaces being evenly distributed with respect to a central line of said extension bar and being spaced at intervals of an angle, each set of engagement surfaces being configured to define a sub-opening that is matched with the drive lug of the handle so that the drive lug of the handle can be engaged with each set of engagement surfaces.

6. The drive tool of claim 5, wherein said drive opening is defined by two sets of engagement surfaces, each set of engagement surfaces being configured to define a square sub-opening, so that the handle can be coupled to said extension bar at intervals of 45 degrees, and the handle can be coupled to said extension bar at eight angle positions in one circle.

7. The drive tool of claim 5, wherein said drive opening is defined by three sets of engagement surfaces, each set of engagement surfaces being configured to define a square sub-opening, so that the handle can be coupled to said extension bar at intervals of 30 degrees, and the handle can be coupled to said extension bar at twelve angle positions in one circle.

8. The drive tool of claim 5, wherein said drive opening is defined by four sets of engagement surfaces, each set of engagement surfaces being configured to define a square sub-opening, so that the handle can be coupled to said extension bar at intervals of 15 degrees, and the handle can be coupled to said extension bar at sixteen angle positions in one circle.
